(19) United States
(12) Patent Application Publication
(10) Pub. No.: US 2023/0415179 A1
(43) Pub. Date: Dec. 28, 2023

(54) LIQUID DISPENSING DEVICE FOR A HIGH PRESSURE CLEANING DEVICE AND METHOD FOR CONTROLLING A HIGH PRESSURE CLEANING DEVICE BY MEANS OF A LIQUID DISPENSING DEVICE

(71) Applicant: Alfred Kärcher SE & Co. KG, Winnenden (DE)

(72) Inventors: Benjamin KUTZ, Winnenden (DE); Lukas SOBOTTA, Winnenden (DE)

(21) Appl. No.: 18/351,161

(22) Filed: Jul. 12, 2023

Related U.S. Application Data
(63) Continuation of application No. PCT/EP2022/050451, filed on Jan. 11, 2022.

(30) Foreign Application Priority Data
Jan. 19, 2021 (DE) 10 2021 101 033.0

(51) Int. Cl. B05B 9/01; B05B 12/00; B05B 12/12; B08B 3/02

(52) U.S. Cl. CPC B05B 9/01; B05B 12/008; B05B 12/122; B08B 3/028

(57) ABSTRACT

A liquid dispensing device for a high pressure cleaning device is provided, and includes a liquid inlet, which is connectable to a pump outlet by a pressure conduit, a liquid outlet, an input apparatus, a display apparatus, and a control unit including a storage member in which control parameters are storable, and wherein at least one control parameter can be output from the control unit to the high pressure cleaning device. In order to further develop the liquid dispensing device to enable an improved cleaning result in a simple manner, the liquid dispensing device includes an object detection unit for contactlessly detecting the object to cleaned, wherein object information corresponding to the object to be cleaned is transmittable from the object detection unit to the control unit and is processable thereby for providing at least one control parameter adapted to the object to be cleaned.

### CROSS-REFERENCE TO RELATED APPLICATIONS

This application is a continuation of international application number PCT/EP2022/050451, filed on Jan. 11, 2022, and claims the benefit of German application number 10 2021 101 033.0, filed on Jan. 19, 2021, which are incorporated herein by reference in their entirety and for all purposes.

### BACKGROUND OF THE INVENTION

The invention relates to liquid dispensing device for a high pressure cleaning device, comprising a liquid inlet, which is connectable to a pump outlet of the high pressure cleaning device by way of a pressure conduit for pressurized cleaning liquid, a liquid outlet for dispensing the cleaning liquid in the direction of an object to be cleaned, an input apparatus, a display apparatus, and a control unit for controlling the high pressure cleaning device, wherein the control unit comprises a storage member in which control parameters are storable, and wherein at least one control parameter can be output from the control unit to the high pressure cleaning device.

The invention also relates to a method for controlling a high pressure cleaning device by means of a liquid dispensing device of the aforementioned type.

High pressure cleaning devices comprise a pump and a motor driving the pump. A cleaning liquid to be pressurized, for example water, can be fed to the pump by way of a pump inlet. The cleaning liquid can be pressurized by the pump and be fed to a liquid inlet of a liquid dispensing device by way of a pump outlet and a pressure conduit connected to the pump outlet, for example a pressure hose. The liquid dispensing device forms an accessory of the high pressure cleaning device and may be configured, e.g., as a spray gun. The pressurized cleaning liquid can be dispensed by the liquid dispensing device in the direction of an object to be cleaned by way of a liquid outlet, which is in flow connection with the liquid inlet. The object to be cleaned may be a floor surface, a building facade, or a vehicle, for example. The object to be cleaned may have a sensitive or less sensitive surface.

WO 2016/066209 A1 discloses a fluid dispensing device, which, in addition to a liquid inlet and a liquid outlet in flow connection therewith, comprises an input apparatus, a display apparatus, and a control unit for controlling the high pressure cleaning device. The control unit comprises a memory member in which control parameters can be stored, which can be output from the control unit to the high pressure cleaning device in order to control the high pressure cleaning device. The control parameters allow the high pressure cleaning device to be operated in a predefinable manner. For example, by means of a control parameter, the pressure of the cleaning liquid prevailing at the pump outlet or, for example, the volume flow of the cleaning liquid conveyed by the high pressure cleaning device can be set in order to achieve the best possible cleaning result.

The respective optimal control parameters depend on which object is to be cleaned. For example, a lower pressure of the cleaning liquid should be set for an object with a sensitive surface than for an object with a less sensitive surface. Less experienced users often do not sufficiently take into account the influence of the control parameters on the cleaning result, such that an optimal cleaning result is not always achieved or sensitive surfaces could be damaged.

In accordance with an embodiment of the invention, a liquid dispensing device of the kind stated at the outset is further developed in such a way that it enables an improved cleaning result in a simple manner.

### SUMMARY OF THE INVENTION

In accordance with an embodiment of the invention, provision is made in the case of a liquid dispensing device of the generic type that the liquid dispensing device comprises an object detection unit for contactlessly detecting the object to be cleaned, wherein object information corresponding to the object to be cleaned is transmittable from the object detection unit to the control unit and is processable by the control unit for providing at least one control parameter adapted to the object to be cleaned.

The liquid dispensing device in accordance with the invention comprises an object detection unit with which the object to be cleaned can be contactlessly detected. For example, a floor surface, a building facade, or vehicle can be contactlessly detected by the object detection unit. Object information corresponding to the object to be cleaned can be transmitted from the object detection unit to the control unit. The control unit is set up to process the transmitted object information and to provide the high pressure cleaning device preferably wirelessly at least one control parameter adapted to the object to be cleaned. On the basis of the at least one control parameter that is provided to the high pressure cleaning device in this way, the high pressure cleaning device can be operated in such a way that an improved cleaning result can be achieved without the need for the user to have in-depth knowledge.

It is advantageous if object information of a multitude of objects together with control parameters corresponding thereto for controlling the high pressure cleaning device are storable in the storage member of the control unit, and the object to be cleaned can be associated with an object stored in the storage member by the control unit on the basis of the information transmitted by the object detection unit and, in dependence on the association, at least one control parameter can be output from the control unit to the high pressure cleaning device. In such a configuration of the liquid dispensing device in accordance with the invention, object information of a multitude of objects together with control parameters corresponding to said objects for controlling the high pressure cleaning device can be stored in the storage member, for example at the manufacturing plant of the liquid dispensing device. The detected object can then be associated by the control unit with an object stored in the storage member. For this purpose, the control unit can check the degree of correspondence of the object to be cleaned with the objects stored in the storage member and associate the detected object with the object stored in the storage member that has the greatest correspondence and output the control parameters corresponding to the associated object to the high pressure cleaning device. In this way, at least one control parameter that is adapted to the object to be cleaned can be provided to the high pressure cleaning device.

In an advantageous embodiment of the invention, the at least one control parameter comprises a conveying parameter of the high pressure cleaning device, in particular a predetermined value or predetermined value range for the pressure of the cleaning liquid, the volume flow of the cleaning liquid, and/or the dosing of a cleaning chemical that can be admixed with the cleaning liquid by the high pressure cleaning device. Depending on which object is to be cleaned, the high pressure cleaning device can be operated on the basis of the provision of the control parameter in the form of a conveying parameter in such a way that it provides cleaning liquid with a pressure that is optimally adapted to the object to be cleaned and/or a volume flow that is optimally adapted to the object to be cleaned and/or admixes a cleaning chemical to the cleaning liquid in an optimal manner.

In a preferred embodiment of the invention, the object detection unit is configured in the form of a camera for capturing an image of the object to be cleaned, and image information corresponding to the object to be cleaned is transmittable to the control unit.

It is favorable if the image information corresponding to the object to be cleaned is comparable with the objects stored in the storage member by the control unit by means of image recognition algorithms. For example, a pattern recognition method may be used for the comparison. The control unit can check which object stored in the storage member has the greatest degree of correspondence with the object to be cleaned. The object to be cleaned can then be associated by the control unit with the stored object that has the greatest degree of correspondence and control parameters that correspond to the associated object can be output from the control unit to the high pressure cleaning device.

In a particularly preferable embodiment of the liquid dispensing device in accordance with the invention, the associated object is displayable on the display apparatus, in particular in the form of a pictogram, an image, and/or a label. The user can thus easily recognize on the display apparatus with which stored object the object to be cleaned that was detected by the object detection unit was associated by the control unit.

It is advantageous if the association made by the control unit of the object to be cleaned with the object displayed on the display apparatus is confirmable by the user by means of the input apparatus, wherein the at least control parameter corresponding to the displayed object can be output from the control unit to the high pressure cleaning device after confirmation. In an embodiment of that kind, the user can decide whether they agree with the association made by the control unit of the object to be cleaned with the object displayed on the display apparatus. If they agree, they can confirm the association. The confirmation then causes the control unit to output at least one control parameter corresponding to the displayed object to the high pressure cleaning device. The risk of control parameters that are not adapted to the object to be cleaned being output due to an incorrect association can thereby be kept particularly low.

Provision may be made that the at least one control parameter corresponding to the displayed object can be automatically output by the control unit to the high pressure cleaning device if user confirmation does not occur within a predetermined display time. In such an embodiment of the liquid dispensing device, it is not absolutely necessary for the user to explicitly confirm the association made by the control unit of the object to be cleaned with the object displayed on the display apparatus. If no confirmation is given by the user within a predetermined display time, the control unit then automatically outputs the at least one control parameter that corresponds to the displayed object. This facilitates the handling of the liquid dispensing device.

It is advantageous if the association made by the control unit of the object to be cleaned with the object displayed on the display apparatus is rejectable by the user by means of the input apparatus and the output of the at least one control parameter corresponding to the displayed object to the high pressure cleaning device is blockable. If the user does not agree with the association made by the control unit of the object to be cleaned that was detected by the object detection unit with the object displayed on the display apparatus, they can reject the association and thereby block the output of the at least one control parameter corresponding to the displayed object.

It is particularly favorable if after rejecting the association made by the control unit of the object to be cleaned with the object displayed on the display apparatus, a re-detection of the object to be cleaned by the object detection unit is triggerable automatically by the control unit or by the user by means of the input apparatus. The object to be cleaned can thus be re-detected by the object detection unit and corresponding object information can be transmitted to the control unit, so that the control unit can perform a new association with an object stored in the storage member. For example, a new image can be captured of the object to be cleaned, provided that the object detection unit is configured as a camera, and the control unit can check on the basis of the new image which stored object has the greatest correspondence with the object to be cleaned. The result of the association can then be displayed again to the user on the display apparatus so that they can again confirm or reject the association. The re-detection of the object to be cleaned can be triggered automatically by the control unit or it can be triggered by the user by means of the input apparatus.

In an advantageous embodiment of the fluid dispensing device in accordance with the invention, the object to be cleaned can be associated with an object stored in the storage member by the user by means of the input apparatus after rejecting the association made by the control unit, and the at least one control parameter that corresponds to the object with which the user associated the object to be cleaned can be output from the control unit to the high pressure cleaning device. In such an embodiment of the liquid dispensing device in accordance with the invention, in a first step, the object to be cleaned can be associated by the control unit with an object stored in the storage member, which can then be displayed on the display apparatus. If the user does not agree with this association, they can reject the association made by the control unit and, in a second step, can themselves associate the object to be cleaned with an object stored in the storage member. According to the association made by the user, at least one control parameter can then be output from the control unit to the high pressure cleaning device.

The association made by the user of the object to be cleaned with an object stored in the storage member is advantageously storable in the storage member. This means that the control unit can be taught by an object being immediately associated with the object specified by the user when said object is detected again.

It is favorable if, after rejecting the association made by the control unit, a suggestion list of objects stored in the storage member is displayable on the display apparatus and the object to be cleaned can be associated with an object selected from the suggestion list by the user. In such an embodiment of the liquid dispensing device, the user, after rejecting an association made by the control unit of the object to be cleaned with an object stored in the storage member, can select an object from a suggestion list that can be displayed on the display apparatus, such that the object to be cleaned that was detected by the object detection unit is then associated with the object selected by the user. The control parameters corresponding to the object selected by the user from the suggestion list can then be output from the control unit to the high pressure cleaning device.

Provision may also be made that after rejecting the association made by the control unit, a new object, which was not previously stored in the storage member, together with one or more control parameters corresponding to the new object can be specified by the user and can be stored in the storage member, wherein the object to be cleaned is then associated with the new object and at least one control parameter corresponding to the new object is output from the control unit to the high pressure cleaning device. Such an embodiment gives the user the possibility to expand the storage content of the storage member by storing a new object together with control parameters corresponding thereto in the storage member, and the object to be cleaned that was detected by the object detection unit can be associated with the new object.

It is advantageous if the association of the object to be cleaned with the new object stored in the storage member by the user is storable. This allows the control unit to be taught by the object to be cleaned, when a new detection is made, being associated with the object stored by the user in the storage member, and the control parameters corresponding to this object being output to the high pressure cleaning device.

It is of particular advantage if the control unit is connectable to an external data processing unit for updating the storage content of the storage member and/or for updating a software program. For example, a server, a computer network (cloud), a smartphone, or a tablet computer can be used as an external data processing unit. Information and preferably also software programs can be provided by the external data processing unit to the control unit of the liquid dispensing device in order to facilitate and/or to expand the processing of object information by the control unit. In particular, the control unit can be taught to output at least one control parameter to the high pressure cleaning unit after detection of an object to be cleaned by the object detection unit, so that the operation of the high pressure cleaning device can be optimally adapted to the object to be cleaned.

The liquid dispensing device forms an accessory for a high pressure cleaning device. For example, the liquid dispensing device may be configured as a spray gun. In this case, the liquid inlet of the liquid dispensing device forms a gun inlet to which a pressure conduit, in particular a pressure hose, can be connected, so that cleaning liquid that was pressurized by the high pressure cleaning device can be supplied to the spray gun by way of the pressure conduit. In such an embodiment, the liquid outlet of the liquid dispensing device is configured as a gun outlet, which is in flow connection with the gun inlet and via which the pressurized liquid can be directed to an object to be cleaned.

The gun outlet is preferably releasably connectable to a discharge unit. The discharge unit may be configured, for example, in the form of a spray lance, a spray nozzle, a washing brush, or a surface cleaning device.

A particularly simple handling of the liquid dispensing device in accordance with the invention is achieved in a preferred embodiment by the input apparatus in combination with the display apparatus forming a touch-sensitive screen (touch screen).

It is favorable if control signals for activating the high pressure cleaning device can be output by the control unit. This allows the user to switch the high pressure cleaning device on and off using the liquid dispensing device. Provision may thus be made, for example, that the liquid dispensing device comprises an operating element that can be actuated by the user. When the operating element is actuated, activation signals can be output from the control unit to the high pressure cleaning device in order to activate the high pressure cleaning device so that cleaning liquid can be pressurized. If the user releases the operating element, the control unit no longer provides activation signals to the high pressure cleaning device, such that the high pressure cleaning device is switched off.

The operating element is advantageously configured as a pivot lever, which is mounted so as to be pivotable about a pivot axis and can be pivoted by the user starting from an inoperative position against a spring-elastic restoring force into an operating position. By pivoting the pivot lever into the operating position, the control unit is triggered to output activation signals for activating the high pressure cleaning device. If the user releases the pivot lever, it pivots into its inoperative position under the effect of the restoring force and thereby causes the control unit to terminate the output of the activation signals.

In order to prevent cleaning liquid from being able to be discharged from the liquid dispensing device when the high pressure cleaning device is switched off, it is advantageous if the liquid dispensing device comprises a check valve, which is arranged in a flow path that connects the liquid outlet to the liquid inlet. When the high pressure cleaning device is switched off, it no longer provides pressurized cleaning liquid to the liquid dispensing device, such that the pressure of the cleaning liquid drops at the liquid inlet and the check valve then automatically adopts its closing position. When the high pressure cleaning device is switched on again, the pressure of the cleaning liquid prevailing at the liquid inlet rises and the check valve automatically adopts its open position and thereby unblocks the flow path between the liquid inlet and the liquid outlet, such that the pressurized cleaning liquid can be discharged via the liquid outlet.

The invention also relates to a method for controlling a high pressure cleaning device by means of a fluid dispensing device, wherein the fluid dispensing device comprises a liquid inlet, which is connectable to a pump outlet of the high pressure cleaning device by way o a pressure conduit for pressurized cleaning liquid, and wherein the liquid dispensing device comprises a liquid outlet, which is in flow connection with the liquid inlet for dispensing the cleaning fluid in the direction of an object to be cleaned, and wherein the liquid dispensing device comprises an input apparatus, a display apparatus, and a control unit for controlling the high pressure cleaning device, wherein the control unit comprises a storage member in which control parameters are storable, wherein at least one control parameter can be output from the control unit to the high pressure cleaning device, and wherein the liquid dispensing device comprises an object detection unit for contactlessly detecting the object to be cleaned, wherein object information corresponding to the object to be cleaned is transmitted from the object detection unit to the control unit and is processed thereby for providing at least one control parameter adapted to the object to be cleaned, which is output to the high pressure cleaning device.

The advantages that have already been discussed in connection with the explanation of the liquid dispensing device in accordance with the invention can also be achieved using the method. In order to avoid repetition, reference is made to the preceding descriptions in this regard.

It is favorable if object information of a multitude of objects together with control parameters corresponding thereto for controlling the high pressure cleaning device are stored in the storage member of the control unit and the object to be cleaned is associated by the control unit with an object stored in the storage member.

The control unit preferably checks the degree of correspondence of the object to be cleaned with the objects stored in the storage member and associates the object to be cleaned with the object stored in the storage member that has the greatest correspondence, and the control parameters corresponding to the associated object are output from the control unit to the high pressure cleaning device.

Alternatively, provision may be made that the control unit associates the detected object with an object specified by the user and then outputs the control parameters corresponding to said specified object to the high pressure cleaning device.

In a preferred embodiment of the method in accordance with the invention, the object detection unit is configured in the form of a camera and captures an image of the object to be cleaned and transmits image information corresponding to the object to be cleaned to the control unit.

The control unit preferably processes the image information of the object to be cleaned provided by the camera by comparing said image information with the objects stored in the storage member by means of image recognition algorithms.

Favorably, image recognition algorithms in the form of pattern recognition methods are used.

The object associated by the control unit with the object to be cleaned is favorably displayed on the display apparatus, in particular in the form of a pictogram, an image, and/or a label. The association made by the control unit of the object to be cleaned with an object stored in the storage member is preferably either confirmed or rejected by the user.

If the user confirms the association made by the control unit, in an advantageous embodiment of the method in accordance with the invention, the at least one control parameter that corresponds to the displayed object is output from the control unit to the high pressure cleaning device. If the association made by the control unit is rejected, the output of the at least one control parameter that corresponds to the object displayed is blocked.

In an advantageous embodiment of the method in accordance with the invention, after rejecting the association made by the control unit, a re-detection of the object to be cleaned by the object detection unit is triggered automatically by the control unit or by the user by means of the input apparatus, and after re-detection a new association of the object to be cleaned with an object stored in the storage member is made by the control unit.

Provision may also be made that the object to be cleaned is associated with an object stored in storage member by the user by means of the input apparatus after rejecting the association made by the control unit, and the at least one control parameter that corresponds to the object with which the user associated the object to be cleaned is output from the control unit to the high pressure cleaning device.

For example, provision may be made that a suggestion list of objects stored in the storage member is displayed to the user on the display apparatus after rejecting the association made by the control unit, and the user selects an object from the suggestion list, and the object to be cleaned is then associated with the selected object and control parameters corresponding to the selected object are output to the high pressure cleaning device.

Provision may also be made that, after rejecting the association made by the control unit, the user stores a new object, which was not previously stored in the storage member, together with one or more control parameters corresponding to the new object in the storage member, wherein the object to be cleaned is then associated with the new object and at least one control parameter corresponding to the new object is output from the control unit to the high pressure cleaning device.

It is particularly advantageous if the control unit is connectable to an external data processing unit, for example to a server, a computer network (cloud), a smartphone, or a tablet computer for updating the storage content of the storage member and/or for updating a software program.

The subsequent description of a preferred embodiment of the invention serves in conjunction with the drawing for further explanation of the invention.

### BRIEF DESCRIPTION OF THE DRAWINGS

FIG. 1 shows a perspective depiction of a liquid dispensing device for a high pressure cleaning device;

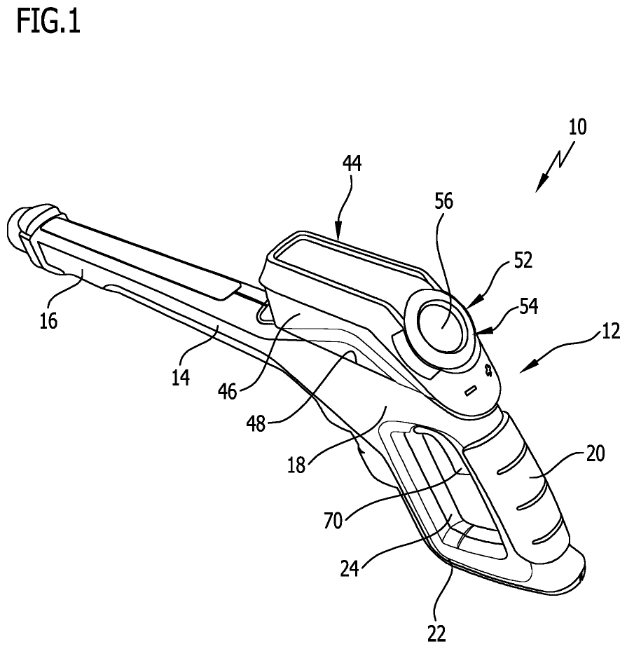

FIG. 2 shows a second perspective depiction of the liquid dispensing device from FIG. 1;

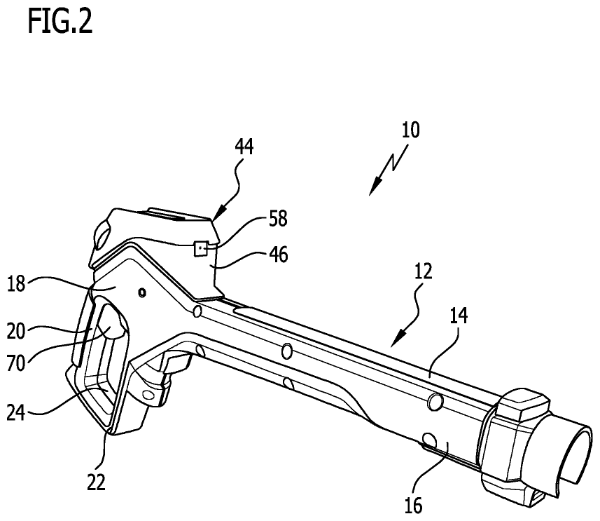

FIG. 3 shows a longitudinal section view of the liquid dispensing device from FIG. 1;

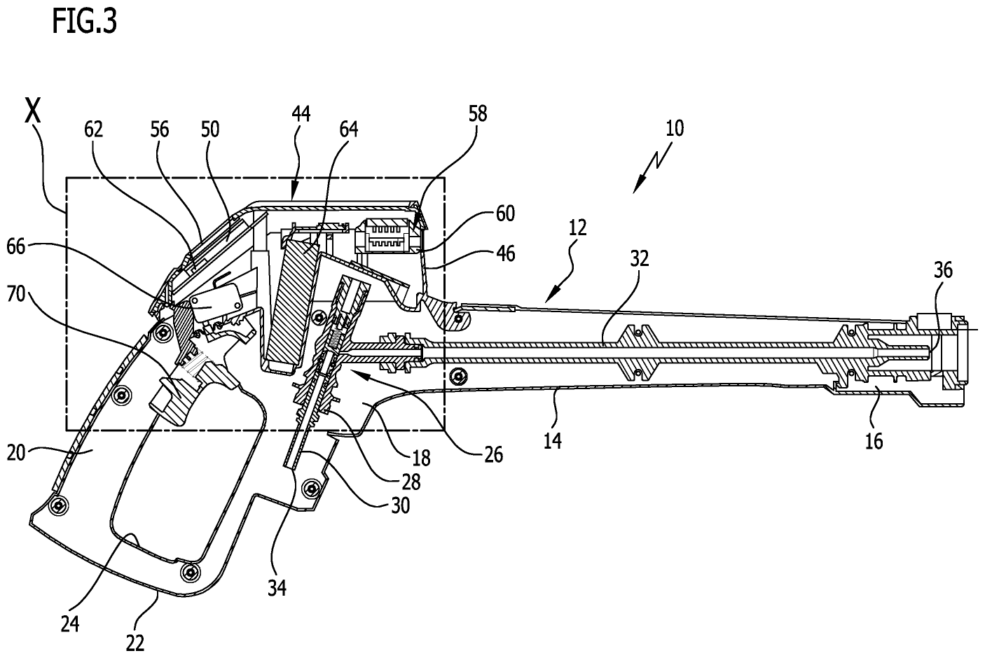

FIG. 4 shows an enlarged depiction of detail X in FIG. 3.

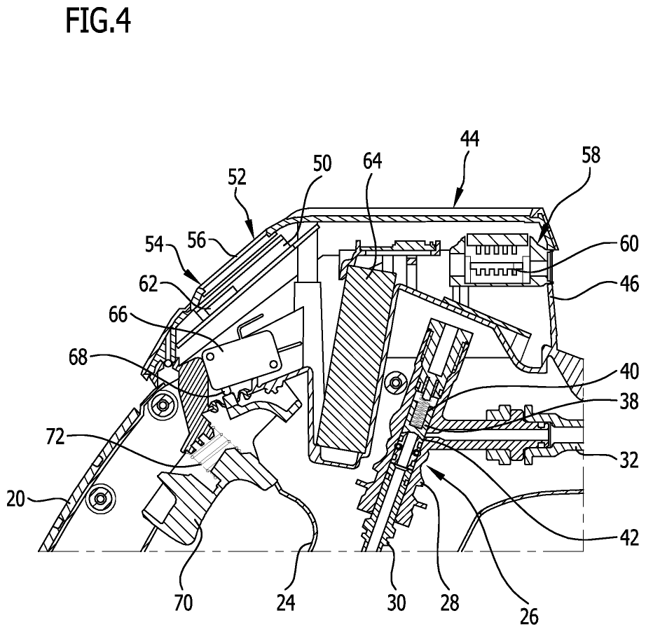

### DETAILED DESCRIPTION OF THE INVENTION

Schematically depicted in the drawing is an advantageous embodiment of a liquid dispensing device in accordance with the invention, which is denoted as a whole with the reference numeral 10.

In the depicted embodiment, the liquid dispensing device 10 is configured in the form of a spray gun 12 and comprises a housing 14 with a front housing region 16 and a rear housing region 18. A handle 20 protrudes from the rear housing region 18, which is adjoined by a protective bracket 22. The protective bracket 22 in combination with the handle 20 and the rear housing region 18 surrounds a handle opening 24 in which the user can engage with their fingers when gripping the handle 20.

Arranged in the rear housing region 18 is a spring-loaded check valve 26, into the valve housing 28 of which an inlet conduit 30 opens and to which an outlet conduit 32 connects. The free end of the inlet conduit 30 forms a liquid inlet 34 and the free end of the outlet conduit 32 forms a liquid outlet 36. In the valve housing 28, a closing member 38 is biased by means of a closing spring 40 into a closing position in which it sealingly abuts against a valve seat 42 and thereby interrupts a flow connection between the liquid inlet 34 and the liquid outlet 36. The closing member 38 can be moved counter to the closing force of the closing spring 40 into an open position in which it adopts a distance from the valve seat 42 and thereby unblocks the flow connection between the liquid inlet 34 and the liquid outlet 36.

A pressure conduit for pressurized cleaning liquid can be connected to the liquid inlet 34 in the typical manner, by way of which the fluid inlet 34 can be connected to the pump outlet of a high pressure cleaning device, which is known per se and therefore is not depicted in the drawing to achieve a better overview, such that cleaning fluid that was pressurized by the high pressure cleaning device can be supplied to the spray gun 12. Under the action of the pressurized cleaning liquid, the closing member 38 of the check valve 26 automatically transitions into its open position, so that the cleaning liquid can be discharged via the outlet conduit 32 and the liquid outlet 36 in the direction of an object to be cleaned. Provision may also be made that a discharge apparatus, for example a spray lance, a spray nozzle, a washing brush, or a surface cleaning device, is able to be connected to the liquid outlet 36, by means of which the object to be cleaned can be acted upon with pressurized cleaning liquid.

High pressure cleaning devices by means of which a cleaning liquid can be pressurized are known to the person skilled in the art. They comprise a motor and a pump driven by the motor as well as control electronics.

The spray gun 12 comprises an electrical unit 44, which is partially accommodated by the rear housing region 18, wherein a raised portion 46 of the electrical unit 44 protrudes from a top side 48 of the rear housing region 18.

The electrical unit 44 is of splash-proof configuration in the form of a pre-mountable unit that can be inserted into the housing 14.

The electrical unit 44 comprises a control unit 50 for controlling the high pressure cleaning device, the pump outlet of which, as already mentioned, is in flow connection with the liquid inlet 34 by way of a pressure conduit. The control unit 50 is set up to communicate wirelessly, in particular by radio, with the control electronics of the high pressure cleaning device in order to control the high pressure cleaning device.

In addition, the electrical unit 44 comprises an input apparatus 52 and a display apparatus 54. The input apparatus 52, in combination with the display apparatus 54, forms a touch-sensitive screen (touch screen) 56.

The electrical unit 44 also comprises an object detection unit 58, which in the depicted embodiment is configured as a camera 60. By means of the camera 60, an object to be cleaned that is arranged in front of the spray gun 12 can be detected. To achieve this, the camera 60 can capture an image of the object to be cleaned.

The camera 60 is in electrical connection with the control unit 50 by way of a connecting line that is not depicted in the drawing and is known per se. The control unit 50 comprises a storage member 62.

The electrical unit 44 comprises a battery 64 for supplying energy. In addition, the electrical unit 44 comprises an electronic switch 66, which is electrically connected to the control unit 50. A switch plunger 68 of the electronic switch 66 can be actuated by the user by means of an operating element, which in the depicted embodiment is configured as a pivot lever 70. The pivot lever 70 is biased by means of a restoring spring 72 into an inoperative position in which it projects into the handle opening 24. The user can pivot the pivot lever 70 with their index finger against the force of the restoring spring 72 into an operating position. As a result, the pivot lever actuates the electronic switch 66 by way of the switch plunger 68, which then transmits a switching signal to the control unit 50. The switching signal causes the control unit 50 to continuously repeatedly transmit an activation signal to the control electronics of the high pressure cleaning device, such that the high pressure cleaning device is switched on by the control electronics and pressurized cleaning liquid is provided to the spray gun 12. The high pressure cleaning device remains switched on until the user releases the switch lever 70, such that it adopts its inoperative position under the action of the restoring spring 72. The adoption of the inoperative position by the pivot lever 70 is detected by the electronic switch 66. The electronic switch 66 then terminates the transmission of a switching signal to the control unit 50, which then no longer provides an activation signal to the control electronics of the high pressure cleaning device, such that the high pressure cleaning device is switched off by the control electronics.

As already mentioned, by means of the camera 60, an image can be captured of an object to be cleaned that is positioned in front of the spray gun. The camera 60 transmits corresponding image information, namely the captured image, to the control unit 50. In the storage member 62 of the control unit 50, object information in the form of images of a multitude of objects are stored together with at least one respective control parameter corresponding to the respective object for the high pressure cleaning device. The control parameters are selected in such a way that the respective object can be optimally cleaned by the high pressure cleaning device. By means of image recognition algorithms, in particular by means of a pattern recognition method, the control unit 50 compares the image of the object to be cleaned provided by the camera 60 with the objects stored in the storage member 62. The control unit 50 hereby checks which of the stored objects has the greatest degree of correspondence with the object to be cleaned. The object to be cleaned is then associated by the control unit 50 with the object stored in the storage member that has the greatest degree of correspondence.

In a further step, the stored object associated with the object to be cleaned is then displayed on the touch-sensitive screen 56 in the form of a pictogram, a label and/or an image. The user can thus recognize on the touch-sensitive screen 56 which stored object the control unit 50 associated with the object to be cleaned.

The user can then either confirm or reject the association made by the control unit 50 by touching corresponding screen fields of the touch-sensitive screen 56.

If the user confirms the association made by the control unit, the control unit 50 outputs the at least one control parameter corresponding to the object displayed on screen 56 to the high pressure cleaning device. The at least one control parameter is transmitted by radio to the control electronics of the high pressure cleaning device. For this purpose, the control unit 50 as well as the control electronics of the high pressure cleaning device comprise a corresponding radio member. After receiving the at least one control parameter, the control electronics control or regulate the operation of the high pressure cleaning device according to the at least one control signal.

The at least one control parameter may comprise, e.g., a conveying parameter of the high pressure cleaning device, in particular a predetermined value or predetermined value range for the pressure of the cleaning liquid, the volume flow of the cleaning liquid, and/or the dosing of a cleaning chemical that can be admixed with the cleaning liquid by the high pressure cleaning device. The control parameter is selected in such a way that it enables an optimal cleaning of the respective object. When the object to be cleaned is correctly associated with an object stored in the storage member 62, the high pressure cleaning device is thus operated in such a way that an optimal cleaning result can be achieved.

If the user rejects the association made by the control unit 50, the at least one control parameter corresponding to the displayed object is not output by the control unit 50 to the control electronics of the high pressure cleaning device. Rather, the control unit 50 automatically triggers a new detection of the object to be cleaned by the camera 60 again capturing an image of the object to be cleaned. Alternatively, provision may be made that the user, after rejecting the association made by the control unit 50, triggers a re-detection of the object to be cleaned by touching a corresponding screen field of the screen 56. The image then taken of the object to be cleaned is then again associated by the control unit 50 with an object stored in the storage member 62, which is then again displayed on the touch-sensitive screen 56.

The user also has the option to prompt the control unit 50 to display a suggestion list of objects stored in the storage member 52 on the screen 56 by touching a corresponding screen field of the screen 56. The user can then select a stored object from the suggestion list. The object to be cleaned that was detected by the camera 60 is then associated with the selected object and the at least one control parameter that corresponds to the selected object is output from the control unit 50 to the high pressure cleaning device.

In addition, the user has the option of storing a new object not previously stored in the storage member 62 together with one or more control parameters corresponding to the new object in the storage member 62, wherein the control parameters corresponding to the new object are then output from the control unit 50 to the high pressure cleaning device.

The association made by the user of the object detected by the camera 60 that is to be cleaned with the new object is stored in the storage member 52, such that when the object to be cleaned is re-detected by means of the camera 60, the association now stored can be automatically performed by the control unit 50.

The storage content of the storage member 62 as well as a software program of the control unit 50 can be updated and supplemented. For this purpose, the control unit 50 can be connected to an external data processing unit, for example to a server, a computer network (cloud), a smartphone or a tablet computer. This makes it possible to store in the storage member 62 object information of a multitude of objects together with corresponding control parameters for controlling the high pressure cleaning device not only at the manufacturing plant of the spray gun 12, but further object information and control parameters can also be stored at a later time by establishing a connection to the external data processing unit. In addition, the software program that is used for processing the object information provided by the object detection unit 58, in particular pattern recognition methods, can be updated.

The detection of the object to be cleaned by means of the object detection unit 58, in particular by means of the camera 60, has the advantage that a best possible cleaning of the object to be cleaned can be carried out without the user needing to have in-depth knowledge to this end. The object to be cleaned is associated with an object, wherein control parameters for optimally cleaning said object are stored in the storage member 62 and can be output from the control unit 50 to the high pressure cleaning device. This makes it possible to easily set the operation of the high pressure cleaning device in such a way that a cleaning that is as optimal as possible of the object to be cleaned can be performed.

1. A liquid dispensing device for a high pressure cleaning device, comprising a liquid inlet, which is connectable to a pump outlet of the high pressure cleaning device by way of a pressure conduit for pressurized cleaning liquid, a liquid outlet for dispensing the cleaning liquid in the direction of an object to be cleaned, an input apparatus, a display apparatus, and a control unit for controlling the high pressure cleaning device, wherein the control unit comprises a storage member in which control parameters can be stored, and wherein at least one control parameter can be output from the control unit to the high pressure cleaning device, wherein the liquid dispensing device comprises an object detection unit for contactlessly detecting the object to be cleaned, wherein object information corresponding to the object to be cleaned is transmittable from the object detection unit to the control unit and is processable by the control unit for providing at least one control parameter adapted to the object to be cleaned.

2. The liquid dispensing device in accordance with claim 1, wherein object information of a multitude of objects together with control parameters corresponding thereto for controlling the high pressure cleaning device are storable in the storage member of the control unit, and the object to be cleaned can be associated by the control unit with an object stored in the storage member and, in dependence on the association, at least one control parameter can be output from the control unit to the high pressure cleaning device.

3. The liquid dispensing device in accordance with claim 1, wherein the at least one control parameter comprises a conveying parameter of the high pressure cleaning device, in particular a predetermined value or predetermined value range for the pressure of the cleaning liquid, the volume flow of the cleaning liquid, and/or the dosing of a cleaning chemical that can be admixed to the cleaning liquid by the high pressure cleaning device.

4. The liquid dispensing device in accordance with claim 1, wherein the object detection unit is configured in the form of a camera for capturing an image of the object to be cleaned, wherein image information corresponding to the object to be cleaned is transmittable to the control unit.

5. The liquid dispensing device in accordance with claim 4, wherein the image information corresponding to the object to be cleaned is comparable with objects stored in the storage member by the control unit using image recognition algorithms.

6. The liquid dispensing device in accordance with claim 2, wherein the object associated with the object to be cleaned by the control unit is displayable on the display apparatus, in particular in the form of a pictogram, an image, and/or or a label.

7. The liquid dispensing device in accordance with claim 6, wherein the association made by the control unit of the object to be cleaned with the object displayed on the display apparatus is confirmable by the user using the input apparatus, wherein the at least one control parameter corresponding to the displayed object is outputtable from the control unit to the high pressure cleaning device after confirmation.

8. The liquid dispensing device in accordance with claim 7, wherein the at least one control parameter corresponding to the displayed object is automatically outputtable from the control unit to the high pressure cleaning device if user confirmation does not occur within a predetermined display time.

9. The liquid dispensing device in accordance with claim 6, wherein the association made by the control unit of the object to be cleaned with the object displayed on the display apparatus is rejectable by the user using the input apparatus and the output of the at least one control parameter corresponding to the displayed object to the high pressure cleaning device is blockable.

10. The liquid dispensing device in accordance with claim 9, wherein after rejecting the association made by the control unit of the object to be cleaned with the object displayed on the display apparatus, a re-detection by the object detection unit of the object to be cleaned is triggerable automatically by the control unit or by the user using the input apparatus.

11. The liquid dispensing device in accordance with claim 9, wherein the object to be cleaned can be associated with an object stored in the storage member by the user using the input apparatus after rejecting the association made by the control unit, and wherein the at least one control parameter that corresponds to the object with which the user associated the object to be cleaned can be output from the control unit to the high pressure cleaning device.

12. The liquid dispensing device in accordance with claim 11, wherein the association made by the user of the object to be cleaned with an object stored in the storage member is storable in the storage member.

13. The liquid dispensing device in accordance with claim 11, wherein after rejecting the association made by the control unit of the object to be cleaned with the object displayed on the display apparatus, a suggestion list of objects stored in the storage member is displayable on the display apparatus and the object to be cleaned can be associated with an object selected from the suggestion list by the user.

14. The liquid dispensing device in accordance with claim 9, wherein after rejecting the association made by the control unit of the object to be cleaned with the object displayed on the display apparatus, a new object not previously stored in the storage member together with one or more control parameters corresponding to the new object is specifiable by the user and storable in the storage member, wherein the object to be cleaned can be associated with the new object and at least one control parameter corresponding to the new object can be output from the control unit to the high pressure cleaning device.

15. The liquid dispensing device in accordance with claim 14, wherein the association of the object to be cleaned with the new object is storable in the storage member.

16. The liquid dispensing device in accordance with claim 1, wherein the control unit is connectable to an external data processing unit, in particular to a server, a computer network, a smartphone, or a tablet computer, for updating at least one of i) the storage content of the storage member and ii) a software program.

17. The liquid dispensing device in accordance with claim 1, wherein the liquid dispensing device is configured as a spray gun.

18. The liquid dispensing device in accordance with claim 1, wherein the input apparatus in combination with the display apparatus forms a touch-sensitive screen.

19. A method for controlling a high pressure cleaning device using a liquid dispensing device, wherein the liquid dispensing device comprises a liquid inlet, which is connectable to a pump outlet of the high pressure cleaning device by way of a pressure conduit for pressurized cleaning liquid, and wherein the liquid dispensing device comprises a liquid outlet for dispensing the cleaning liquid in the direction of an object to be cleaned, and wherein the liquid dispensing device comprises an input apparatus, a display apparatus, and a control unit for controlling the high pressure cleaning device, wherein the control unit comprises a storage member in which control parameters are storable, and wherein at least one control parameter can be output from the control unit to the high pressure cleaning device, and wherein the liquid dispensing device comprises an object detection unit for contactlessly detecting the object to be cleaned, wherein object information corresponding to the object to be cleaned is transmitted from the object detection unit to the control unit and is processed by the control unit for providing at least one control parameter adapted to the object to be cleaned, which is output to the high pressure cleaning device.

20. The method in accordance with claim 19, wherein object information of a multitude of objects together with control parameters corresponding thereto for controlling the high pressure cleaning device are stored in the storage member of the control unit, and the object to be cleaned is associated by the control unit with an object stored in the storage member and at least one control parameter corresponding to the associated object is output from the control unit to the high pressure cleaning device.

21. The method in accordance with claim 19, wherein the object detection unit is configured in the form of a camera and captures an image of the object to be cleaned and transmits image information corresponding to the object to be cleaned to the control unit.

22. The method in accordance with claim 21, wherein the image information provided by the camera is compared by the control unit with the objects stored in the storage member using image recognition algorithms.

23. The method in accordance with claim 20, wherein the object associated by the control unit with the object to be cleaned is displayed on the display apparatus, in particular in the form of at least one of i) a pictogram, ii) a label, and iii) an image.

24. The method in accordance with claim 23, wherein the association made by the control unit of the object to be cleaned with the object displayed on the display apparatus is either confirmed or rejected by the user, wherein in the case of confirmation the at least one control parameter corresponding to the displayed object is output from the control unit to the high pressure cleaning device, and wherein in the case of rejection the output of the at least one control parameter corresponding to the displayed object to the high pressure cleaning device is blocked.

25. The method in accordance with claim 24, wherein after rejecting the association made by the control unit of the object to be cleaned with the object displayed on the display apparatus, a re-detection of the object to be cleaned by the object detection unit is triggered automatically by the control unit or by the user using the input apparatus, and after re-detection a new association of the object to be cleaned with an object stored in the storage member is made by the control unit.

26. The method in accordance with claim 24, wherein the object to be cleaned is associated with an object stored in the storage member by the user after rejecting the association made by the control unit, and wherein at least one control parameter that corresponds to the object with which the user associated the object to be cleaned is output from the control unit to the high pressure cleaning device.

27. The method in accordance with claim 26, wherein the association made by the user of the object to be cleaned with an object stored in the storage member is stored in the storage member.

28. The method in accordance with claim 24, wherein a suggestion list of objects stored in the storage member is displayed to the user on the display apparatus after rejecting the association made by the control unit, and wherein the user selects an object from the suggestion list, wherein the object to be cleaned is then associated with the selected object and control parameters corresponding to the selected object are output to the high pressure cleaning device.

29. The method in accordance with claim 24, wherein the user, after rejecting the association made by the control unit, stores a new object, which was not previously stored in the storage member, together with one or more control parameters corresponding to the new object in the storage member, wherein the object to be cleaned is then associated with the new object and at least one control parameter corresponding to the new object is output from the control unit to the high pressure cleaning device.

30. The method in accordance with claim 29, wherein the association of the object to be cleaned with the new object is stored in the storage member.

31. The method in accordance with claim 19, wherein the control unit is connected to an external data processing unit for updating at least one of i) the storage content of the storage member and ii) a software program.
